(19) United States
(12) Patent Application Publication
(10) Pub. No.: US 2006/0167610 A1
(43) Pub. Date: Jul. 27, 2006

(54) Gear control unit for a transmission of a drivetrain of a vehicle

(76) Inventors: Marco Reinards, Bleialf (DE); Nicolai Tarasinski, Frankenthal (DE); Ralf Hirschpek, Mannheim (DE)

Correspondence Address: W. Michael Dixon;Deere & Company, Patent Dept, One John Deere Place, Moline, IL, 61265-8098, US

(21) Appl. No.: 11/313,472

(22) Filed: Dec. 21, 2005

(30) Foreign Application Priority Data
Jan. 24, 2005 (DE) 10 2005 000 006.1

(51) Int. Cl. G06F 17/00

(52) U.S. Cl. 701/56; 701/51

(57) ABSTRACT

A gear control unit for a transmission of a drivetrain of a vehicle. The gear control unit being equipped with an electronic control unit in communication with a signal source for transmitting and receiving signals for the purpose of providing information with respect to the operating state of the motor. A strategy input device is in communication with the electronic control unit and functions for the purpose of selecting between at least a first shift and a second shift strategy corresponding to a high-load operation. The electronic control unit is equipped to be able to select the actuator for selection of the gear ratio based on the received signals.

### BACKGROUND

1. Field of the Invention

The invention relates to a gear control unit for a transmission of a drivetrain in a tractor.

2. Description of the Related Art

As shown in U.S. Pat. No. 6,002,976, the drivetrain of a tractor includes an engine, a shifted multi-speed transmission, a reversing unit, a drive clutch, an optional creeper transmission, a shifted range transmission, a rear axle differential which the drive rear wheels. The shifted multi-speed transmission is configured as a power shift transmission, also called a partial power shift transmission, including planetary gear sets with clutches and brakes, enabling shifting of the gears under load. For shifting the gears, control signals are transmitted from a gearshift lever to a control unit, which controls an actuator. The actuator acts upon the power shift transmission and controls the shift processes. The range shift transmission is a fully synchronized shifted transmission whose ranges can be adjusted by a range shift lever. A direction control lever is used for shifting the reversing unit between forward and reverse directions. The drivetrain has a smooth succession of gear ratios and offers the possibility of shifting the gears under load within a selected range of gears.

U.S. Pat. No. 6,002,976 suggests automatically adjusting the gear of the power shift transmission during a gear change of the synchronized transmission. In order to accomplish this, a gear of the power shift transmission is selected and automatically adjusted, for which the rotational speeds of both sides of the drive clutch differ as little as possible. By so doing, the operator only has to operate the shift range transmission manually. However, this configuration still requires operator intervention in order to select the respectively suited gear ratio.

U.S. Pat. No. 4,576,065 describes another automatic transmission for a vehicle. The gear ratio is selected automatically by a control unit as a function of the throttle position, engine speed and vehicle speed. Means are provided for selecting the operating mode, such as an optimized fuel economy mode or optimal performance mode. The gears are selected automatically as a function of the selected operating mode and the operating state of the vehicle. During downshifts of the transmission, especially on inclines, a determination is made whether gears may be skipped without exceeding the permissible rotational speed of the driving motor upon re-engagement so as to prevent unnecessary deceleration of the vehicle or stalling of the engine. Skipping gear ratios is only provided for downshifts regardless of the selected operating mode.

U.S. Pat. No. 6,325,743 describes a different automatic transmission, which checks whether gears may be skipped based on the operating conditions of the driving motor during upshifts.

U.S. Pat. No. 6,480,774 describes a convertible transmission for a vehicle in which a programmable controller drives the transmission in a first or a second operating configuration. The selected operating configuration depends on the application of the vehicle. In the first operating configuration, more or fewer gear ratios from the number of available gear ratios of the transmission may be selected than in the second operating configuration. By doing so, the same transmission may be used, for example, in a semi-truck with 18 gears or in a tipper truck with 10 gears. If one gear ratio is defective, the controller can be programmed to no longer use it.

Therefore, there exists a need for a gear control unit for a tractor, which provides for the automatic selection of gear ratios during upshifts and downshifts based on an operator selected shift strategy.

### BRIEF SUMMARY

In satisfying the above need, as well as overcoming the enumerated drawbacks of the related art, a gear control unit, which enables the automatic selection of gear ratios of a transmission, preventing unnecessary gear ratio changes is provided. A control unit of the gear control unit is fed information by a signal source regarding the operating state of the motor, for example the load of the motor, the rotational speed of the motor and/or the position of a rotational speed setting device for the purpose of specifying the rotational speed of the motor (e.g. gas pedal or hand throttle lever). Moreover, the control unit is connected to a strategy input device, enabling the operator to enter a desired shift strategy. By doing so, the operator may select between a first shift strategy, which involves an energy-saving travel mode and is suited for a low load of the vehicle, and a second shift strategy, which provides a high driving power and is suited for a high load of the vehicle. The control unit selects an actuator, which selects the respective gear ratio of the transmission.

It is suggested that the control unit selects only a first (partial) number of available gear ratios of the transmission in the first shift strategy, with the second number of gear ratios, available to the control unit in the second shift strategy, being greater than the first number. The control unit reproduces the manual shifting behavior of a human operator because not all possible gear ratios are shifted up or down in sequence. For example, it may be more efficient if several gear ratios are skipped. The shift order follows a firmly specified sequence depending on the selected shift strategy. The operator may select between the first shift strategy and the second shift strategy, which should be selected as a function of the load state of the vehicle.

In the first shift strategy (i.e. energy saving travel mode), shifts by a higher number of ratios are accomplished by skipping possible gear ratios than in the case of a second shift strategy (i.e. high driving power for high load), where a greater number of gear ratios are being utilized. In particular, in the case of the first shift strategy, not all available gear ratios are shifted sequentially, thus, increasing the work vehicle's productivity because during acceleration, the target speed is reached more quickly. Wear is reduced by reducing shifting operations, thereby making the shifting process become more pleasant for the driver. No complex calculations are required for determining the next gear ratio to be selected.

Preferably, automatic shifting occurs as a function of the rotational speed of the motor, acceleration of the motor, the position of the rotational speed input device (gas pedal or hand throttle) and the fuel injection amount. It is possible to perform the automatic shift as a function of one of these parameters or as a function of any random combination of these parameters. The resulting values of the parameters leading to a shift are fixed beforehand. However, it would be conceivable to allow for manual operator adjustment of several or all of these parameters.

The transmission may have various configurations. The transmission may be a multi-stage mechanical transmission with a torque converter arranged upstream, as used in passenger vehicles, or may be a mechanical transmission with sufficiently many gear ratios and an automatically shifted clutch or comprise planetary gears and friction clutches. In a preferred embodiment, the transmission comprises a power shift transmission with planetary gear sets and clutches and brakes, enabling shifting of the gears under load, and a synchronized transmission, which is either arranged upstream or downstream. The power shift transmission and the synchronized transmission are each equipped with an actuator for selecting the gear ratios. Since both actuators may be selected independently from each other by the control unit, a high number of different gear ratios are available by multiplying the number of gear ratios of the power shift transmission with the number of gear ratios of the synchronized transmission. In the drivetrain between the driving motor and the wheels (or crawlers) an additional clutch is inserted, which may be moved between an open and closed position by means of a clutch actuator. The clutch actuator is automatically controlled by the control unit.

When the transmission is in operation, the control unit uses only a partial number of the possible actuator position combinations of the power shift transmission and the synchronized transmission if the first shift strategy has been selected. If, however, the second shift strategy is selected, a larger number, but not necessarily all, of possible actuator position combinations of the power shift transmission and the synchronized transmission is used.

The control unit continuously or at certain time intervals checks whether a change to a higher gear ratio, i.e. an upshift, would be favorable. In doing so, the control unit may check whether the rotational speed setting device is above a certain (first) specified rotational speed value and, at the same time, whether the rotational speed of the driving motor is above a certain (first) driving motor rotational speed value, wherein at the same time the load of the driving motor is beneath a certain (first) load value. Hence, a shift occurs when the first rotational speed, according to the operator specification, is exceeded and the load of the driving motor is greater than the first load value. Preferably, in this case, only the first driving motor rotational speed value depends on the selected shift strategy. In the first shift strategy, the first driving rotational speed value is smaller than in the second shift strategy.

The control unit also continuously or at certain intervals checks whether a change to a lower gear ratio, i.e. a downshift, is favorable. It is useful to perform a downshift when the load of the driving motor has led to a drop in the rotational speed below a second driving motor rotational speed value. Accordingly, the driving motor rotational speed is checked to determine whether the rotational speed of the driving motor is below the second driving motor rotational speed and, at the same time, whether the acceleration of the driving motor is beneath a second acceleration value so as to avoid that the acceleration of the engine leads to undesirable shifts while the clutch is disengaged during the shifting operations. Furthermore, a downshift should occur when the operator indicates by lifting off the throttle. This condition may be recognized in that the rotational speed of the driving motor is below a certain (third) driving motor rotational speed and the rotational speed setting device is beneath a predetermined third specified rotational speed value. Preferably, in this case, only the second driving motor rotational speed value depends on the selected shift strategy.

These and other aspects and advantages of the present invention will become apparent upon reading the following detailed description of the invention in combination with the accompanying drawings.

### BRIEF DESCRIPTION OF THE DRAWINGS

FIG. 1 is a side view of an agricultural work vehicle in the form of a tractor having work equipment attached embodying the principles of the present invention;

FIG. 2 is a block diagram of the drivetrain and the gear control unit of the work vehicle embodying the principles of the present invention;

FIG. 3 is a flow chart illustrating the method utilized by the gear control unit embodying the principles of the present invention; and

FIGS. 4a, 4b, 4c and 4d are the conditions queried for the method shown in FIG. 3.

### DETAILED DESCRIPTION

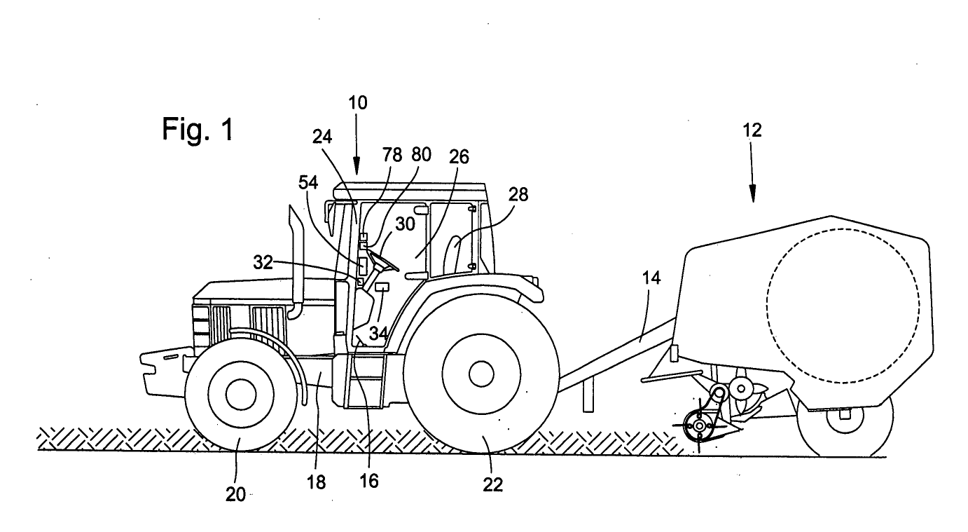

FIG. 1 shows a lateral view of an agricultural work vehicle 10 in the form of a tractor and a piece of work equipment 12 in the form of a round baler, which is connected to a clutch (not illustrated) of the work vehicle 10 by means of a drawbar 14. The work vehicle 10 is arranged on a carrying frame 18, which is supported by steerable front wheels 20 and drivable rear wheels 22 and carries a cab 24 having an operator work place 26.

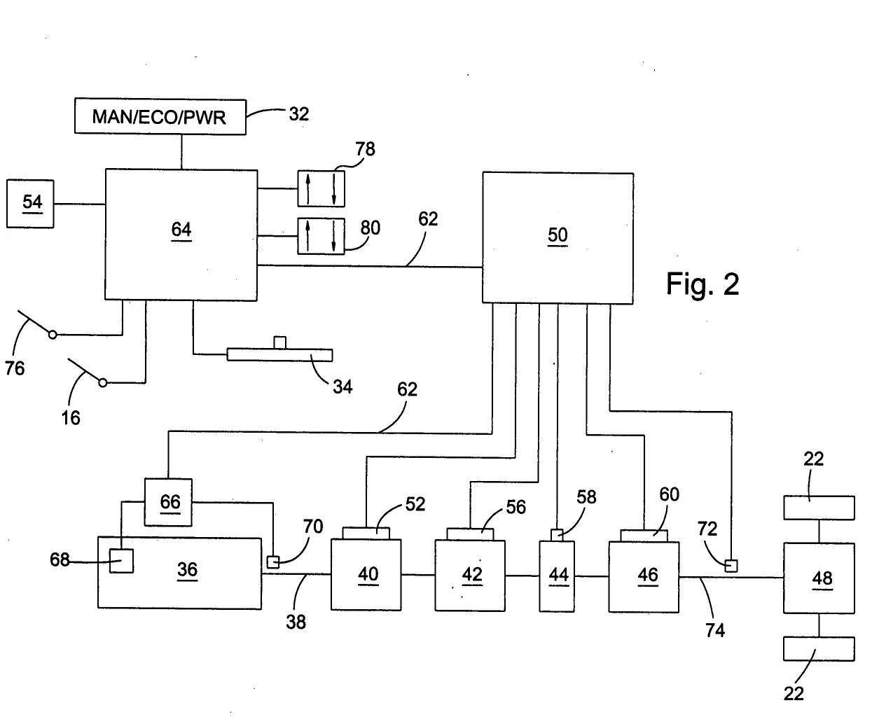

The operator work place 26 comprises a seat 28, a steering wheel 30, a gas pedal 16, a clutch pedal 76 (see FIG. 2) and a pedal for the brake (not shown) as well as several input elements. The input elements are disposed within the reach of the operator located in the operator work place 26. The input elements include a strategy input device 32 for selecting a shift strategy of the transmission for the drivetrain, a reversing switch 54, gear shift input elements 78 and 80, and a hand throttle lever 34. The strategy input device 32, the gear shift input elements 78 and 80 and the reversing switch 54 could also be implemented as a menu item on a virtual terminal of a bus system operating in accordance with ISO 11783. The gas pedal 16 and the hand throttle lever 34 are hereinafter jointly referred to as the rotational speed setting device. Alternatively or additionally, a drive lever may be used as the rotational speed setting device.

FIG. 2 is a block diagram of the drive configuration of the work vehicle 10 for driving the rear wheels 22. A motor 36 in the form of an internal combustion engine, generally a diesel engine, drives a shaft 38, which drives the rear wheels 22 and, preferably, also the front wheels 20, and, possibly, other drivable devices of the work vehicle 10, such as an air conditioning system and/or a power generator. The drivetrain illustrated in FIG. 2 includes a power shift transmission 40 driven by the shaft 38, a reversing unit 42, a clutch 44, a synchronized transmission 46 and a differential 48, which drives the rear wheels 22. If the drivetrain is configured to drive the front wheels 20 additional differential gears may be provided.

The power shift transmission 40 is a partial power shift transmission for shifting the gears under load. For shifting the gears, a control unit 50 sends a corresponding electric signal to a first actuator 52. The first actuator 52 actuates the power shift transmission 40 using electric or hydraulic signals. The synchronized transmission 46 is configured as a shifted range transmission. The reversing unit 42 drives the switch between forward and reverse travel and may be switched by means of an actuator 56, which is connected to the control unit 50 and controlled by the reversing switch 54. The control unit 50 is further connected to a clutch actuator 58, which drives the movement of the clutch between a separated position, in which the drivetrain is interrupted, and a connected position, in which the drivetrain is closed. Another actuator 60, connected to the control unit 50, drives the electric or hydraulic selection of the respective range of the synchronized transmission 46, which is accomplished using an external force.

The electronic control unit 50 is connected via a bus 62, such as a controller area network bus to an operator interface logic 64. The interface logic 64 is connected to the strategy input device 32, the rotational speed setting device (gas pedal 16 and hand throttle lever 34), the clutch pedal 76, the gear shift input elements 78 and 80 and the reversing switch 54. The gas pedal 16 and the clutch pedal 76 are each equipped with sensors, which transmit electric signals to the operator interface logic 64 containing information about the respective position of the pedals 16, 76. The control unit 50 is further connected via the bus 62 to an engine control 66, which in turn controls a fuel injection system 68 of the internal combustion engine 36 and which is fed information about the rotational speed of the shaft 38 by a speed sensor 70. A second speed sensor 72, which is connected to the control unit 60, captures the respective rotational speed of the output shaft 74 of the synchronized transmission 46. The speed sensors 70 and 72 may cooperate with the corresponding shafts 38 or 74 optically (by means of punched encoders, which are connected to the shaft 38, 74 and cooperate with light barriers) or magnetically (by means of permanent magnets, which are connected to the shaft 38, 74 and cooperate with induction coils, reed relays or Hall Effect sensors) or capture the rotational speed in any other random manner. The engine control 66, which may query the fuel injection system 68 and the speed sensor 70, and the rotational speed setting device (gas pedal 16 and hand throttle lever 34), serve as signal sources for providing information about the operating state of the motor 36 for the control unit 50.

With a standing vehicle 10, the operator may reverse the drivetrain by using the reversing switch 54. During reverse travel, the automatic system described below is turned off and/or limited to actuating the actuator 52 of the power shift transmission 40.

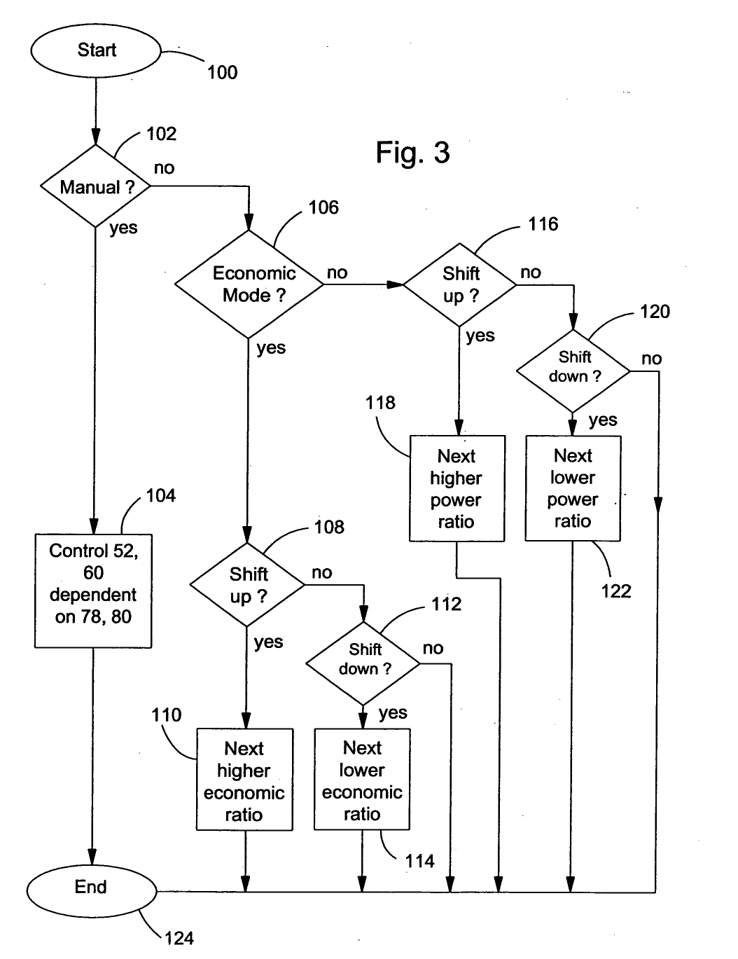

FIG. 3 shows a flow chart illustrating the operation of the control unit 50 of the gear control unit. The strategy input device 32 provides the operator with the possibility of selecting among at least three operating modes. After the start in step 100, which is performed at regular intervals, e.g. every 100 ms, a query is performed in step 102 as to whether the operator has selected a manual operation with the strategy input device 32. If this is the case, the method proceeds to step 104, where the actuator 52 for the power shift transmission 40 and the actuator 46 for the synchronized transmission 46 are controlled in accordance with the input in the gear shift input elements 78 and 80 so that the operator may select the gear of the power shift transmission 40 manually using the gear shift input element 78 and the range of the synchronized transmission 46 using the gear shift input element 80. Step 104 is followed by step 124, where the method ends. During manual operation, the clutch 44 is controlled via the clutch actuator 58 and the control unit 50 by the clutch pedal 76. The operator specifies a desired travel speed using the gas pedal 16 or the hand throttle lever 34. The control unit 50 transmits information about the position of the gas pedal 16 or the hand throttle lever 34 to the engine control 66, which initiates the fuel injection system 68 to feed fuel as specified for the position of the gas pedal 16 or the hand throttle lever 34 to the motor 36.

The strategy input device 32 allows the selection of a first automatic shift strategy, which has been designated by ECO for an economical mode of operation, and the selection of an automatic second shift strategy, which has been designated by PWR for a high-power mode of operation. If in step 102 manual operation is not selected, step 106 follows with a query as to whether the first shift strategy was selected. If so, it is determined in step 108 whether an upshift of the gear ratio should be performed. If this is the case, then the next higher gear step provided for the first shift strategy is selected in step 110. If an upshift is not efficient, a query is run in step 112 as to whether a downshift should occur. If so, in step 114, the next lower gear ratio provided for the first shift strategy is selected. If no shift is supposed to be performed, the method terminates with step 124.

If step 106 shows that the first shift strategy was not selected, consequently, the second shift strategy is determined to have been chosen. In this case, step 116 determines whether an upshift of the gear ratio should be performed. If so, in step 118, the next higher gear ratio provided for the second shift strategy is selected. If an upshift is not efficient, a query is run in step 120 as to whether a downshift should occur. If this is the case, the next lower gear ratio provided for the first second shift strategy is selected in step 122. If no shift is supposed to be performed, the method terminates with step 124.

The gears of the power shift transmission 40 and ranges of the synchronized transmission 46 used in steps 110 and 114 for the first shift strategy are limited to a (first) partial number of the actually available combinations. In this shift strategy not all range-gear combinations are shifted sequentially, leading to faster shifting processes. The first shift strategy is especially suited for applications in which the work vehicle 10 is operating at a low load, e.g. when driving on a road without trailer or equipment 12. The combinations employed for the first shift strategy have relatively little overlaps, yet are sufficiently large to cover the entire forward driving speed range with the available speed range of the driving motor 36, which at low load is relatively large.

The gears of the power shift transmission 40 and ranges of the synchronized transmission 46 used in steps 118 and 122 comprise a larger number of the actually available combinations, yet not necessarily all of them. In this shift strategy, considerably more range-gear combinations are shifted than in the first shift strategy, ensuring better utilization of the driving motor 36. The second shift strategy is especially suited for applications in which the work vehicle 10 experiences high loads, e.g. when cultivating a field or driving on a steep road with a trailer or equipment 12. The combinations employed for the second shift strategy have larger overlaps in order to cover the entire forward driving speed range with the rotational speed range of the driving motor 36 suited for providing the necessary power, which in this case is smaller than for the first shift strategy.

In both shift strategies, the operator specifies a desired travel speed through the gas pedal 16 or the hand throttle lever 34. The control unit 50 transmits information about the position of the gas pedal 16 or the hand throttle lever 34 to the engine control 66, which initiates the fuel injection system 68 to supply the amount of fuel specified for this position of the gas pedal 16 or the hand throttle lever 34 to the motor 36. During the shifting processes, the clutch actuator 58 is initiated via the control unit 50 to disengage the clutch 44 prior to the shift and engage the clutch 44 after the shift. The clutch 44 is also disengaged automatically when the speed of the work vehicle 10 measured by the speed sensor 72 drops below a threshold value during braking so as to prevent stalling of the driving motor 36.

It is noted that it is conceivable to allow operating modes to be selected using the strategy input device 32 in which only the power shift transmission 40 is shifted automatically. Here, a shift strategy may be selected for shifting at low speeds, corresponding to a low load, or a shift strategy for shifting at high speeds, corresponding to a higher load. Moreover, it is feasible to allow an operating mode to be selected in which the synchronized transmission 46 is selected manually and that the power shift transmission 40, after a manually controlled shifting process of the synchronized transmission 46, is automatically brought to a gear ratio at which the speed differential at the input and output of the clutch 44 is as low as possible in order to enable smooth engagement. For this purpose, the rotational speed of the driving motor 36 may be changed by means of the engine control 66. If one or more of the lower gear ratios of the synchronized transmission 46 have been selected manually, the described automatic system may be turned off automatically or limited to shift processes of the power shift transmission 40. It may also be feasible to actuate the gear shift input elements 78 and 80 with an activated first or second shift strategy. The control unit 50 then follows the operator request and adjusts the actuators 52 or 60.

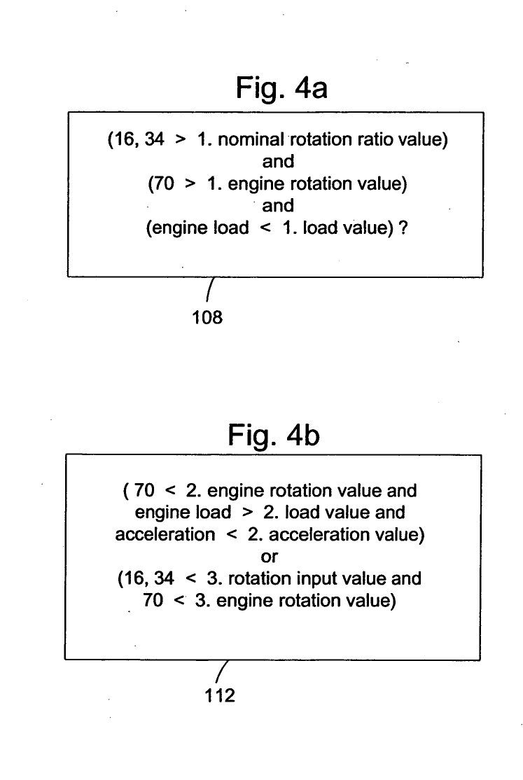

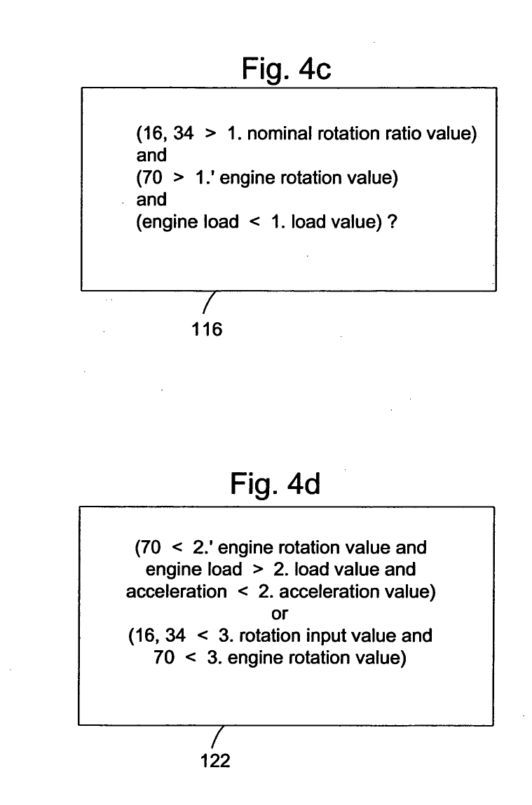

FIG. 4a describes step 108 in more detail. An upshift occurs when the rotational speed setting device (gas pedal 16 or hand throttle lever 34) is above a redefined first specified rotational speed value and, at the same time, the rotational speed of the driving motor 36 measured by the speed sensor 70 is greater than a predefined first driving motor rotational speed value and the load of the driving motor 36 is smaller than a first predefined load value. The load of the driving motor 36 is determined based on the present fuel flow in the fuel injection system 68, which is measured by the engine control 66, while taking the present acceleration of the driving motor 36 captured by the speed sensor 70 into consideration. This prevents an apparently high load from being determined for a driving motor 36 running at no load, which consumes high amounts of fuel. An upshift only occurs when the operator applies sufficient throttle, the rotational speed of the driving motor 36 is higher than the first rotational speed and the driving motor 36 does not experience too much load.

FIG. 4b illustrates step 112 in more detail. A downshift occurs when one of two combinations of conditions exists. The first combination exists when the driving motor 36 operates at a relatively high load. In this case, the motor's 36 rotational speed is below a second rotational speed value and the motor's 36 acceleration is below a second acceleration value, and, at the same time, the motor load, which is determined like in step 108, is greater than a second predefined load value. The second combination exists when the operator would like to decelerate and lifts off the throttle. In this case, the rotational speed setting device (gas pedal 16 or hand throttle lever 34) is below a predefined third specified rotational speed value, and the rotational speed of the driving motor 36 is below a predefined third driving motor rotational speed value. If one of the described combinations of conditions exists, a downshift of the gear ratio is performed.

With the first shift strategy (FIGS. 4a and 4b), the first and second motor rotational speed values may be identical (e.g. 1600 RPM). The third driving motor rotational speed value is below that (e.g. 1300 RPM). The second specified rotational speed value is smaller than the first specified rotational speed value, and the first engine load value is smaller than the second engine load value.

FIGS. 4c and 4d illustrate the steps 116 and 122. The same queries as in steps 108 and 112 are performed, the only difference being that other values are used for the first and second driving motor rotational speeds. The corresponding reference numerals have been designated by an apostrophe, respectively. The remaining parameters are identical to those in the first shift strategy. In step 4c the first driving motor rotational speed value is, for example 2000 RPM, while the second driving motor rotational speed value in step 4d may be, for example, 1700 RPM. Accordingly, in the second shift strategy, an upshift occurs at higher speeds (step 116) than in the first shift strategy, and a downshift occurs already at higher speeds (step 122).

The operator may also perform the disengagement himself in the automatic operating modes using the clutch pedal 76. When the clutch 44 has been separated, the ranges and gears are shifted automatically, independently from the process illustrated in FIG. 3. The coasting speed of the work vehicle 10 is detected by the speed sensor 72, and as the coasting speed changes, the corresponding gear ratios of the power shift transmission 40 and the synchronized transmission 46 are selected so that the speed differential between the rotational speeds at the input and at the output of the clutch 44 is as low as possible. For this purpose, the rotational speed of the driving motor 46 may be modified via the engine control 66. In this operating mode, contrary to the above-described shift strategies, all range-gear combinations are available. After re-engagement, the described automatic system is activated again.

1. A gear control unit for a drivetrain of a vehicle, the drivetrain having a motor and a transmission, the gear control unit comprising:
an electronic control unit in communication with a signal source for transmitting and receiving signals indicative of the operating state of the motor;
a strategy input device in communication with the electronic control unit for selecting at least one of a first shift strategy corresponding to an energy-saving mode of operation and a second shift strategy corresponding to a high-load operation; and
the electronic control unit being configured to select a first number of possible gear ratios of the transmission when a first shift strategy has been selected, and a second number of possible gear ratios of the transmission when a second shift strategy has been selected, the second number of possible gear ratios being greater than the first number of possible gear ratios.

2. The gear control unit according to claim 1, wherein the signal source, provides information to the electronic control unit regarding at least one of the load of the driving motor and the rotational speed of the driving motor.

3. The gear control unit according to claim 1, wherein the electronic control unit is configured to utilize at least two different shifting conditions for the first and second shift strategies.

4. The gear control unit according to claim 1, wherein the transmission further comprises a power shift transmission and a synchronized transmission, the power shift transmission and the synchronized transmission are each equipped with an actuator for selecting a gear ratio.

5. The gear control unit according to claim 4, wherein the control unit is configured to select only a first number of possible combinations of positions of the actuators of the power shift transmission and the synchronized transmission when the first shift strategy has been selected; and
the control unit being configured to select a second number of possible combinations of positions of the actuators of the power shift transmission and the synchronized transmission when the second shift strategy has been selected, the second number being greater that the first number.

6. The gear control unit according to claim 3, wherein the electronic control unit is configured to shift the transmission in a higher gear ratio when the following conditions are satisfied: the rotational speed setting device is above a predefined first specified rotational speed value and the rotational speed of the motor is above a predefined first driving motor rotational speed value and the load of the driving motor is below a predefined first load value, the amount of the first driving motor rotational speed value depending on the selected shift strategy.

7. The gear control unit according to claim 2, wherein the electronic control unit is configured to shift the transmission to a lower gear ratio when the following conditions are satisfied: the rotational speed of the motor is below a predefined second driving motor rotational speed value and the load of the driving motor is above a predefined second load value and the acceleration of the motor is below a predefined second acceleration value, the amount of the second driving motor rotational speed value depending on the selected shift strategy.

8. The gear control unit according to claim 2, wherein the electronic control unit is configured to shift the transmission to a lower gear ratio when the following conditions are satisfied: the rotational speed setting device is below a predefined third specified rotational speed value and the rotational speed of the motor is below a predefined third motor rotational speed value.

9. The gear control unit according to claim 4, further comprising a clutch disposed between the power shift transmission and the synchronized transmission; and
the electronic control unit being configured to adjust the actuators of the power shift transmission and the synchronized transmission when the operator disengages so that the lowest possible speed differential exists at the input and the output of the clutch.

10. A method for operating a gear control unit for a transmission of a drivetrain of a vehicle, the drivetrain having a motor and a transmission, the gear ratio of which may be selected by an actuator the method comprising the steps of:
transmitting signals to a strategy input device indicative of the operating state of the motor;
selecting between at least a first shift strategy corresponding to an energy-saving mode of operation and a second shift strategy corresponding to a high-load operation;
selecting a predefined first number of possible gear ratios of the transmission when a first shift strategy has been selected; and
selecting a second number of possible gear ratios of the transmission when a second shift strategy has been selected, the second number of possible gear ratios being greater than the predefined first number of possible gear ratios.

11. The method of claim 10, further comprising the step of shifting the transmission to a higher gear ratio when the following conditions are satisfied: the rotational speed of the motor is above a first motor rotational speed value and a rotational speed setting device is above a first rotational speed value and the load of the motor is below a first load value.

12. The method of claim 10, further comprising the step of shifting the transmission to a lower gear ratio when the following conditions are satisfied: the rotational speed of the motor is below a second driving motor rotational speed value and the load of the driving motor is above a second load value and the acceleration of the motor is below a second acceleration value.

13. The method of claim 10, further comprising the step of shifting the transmission to a lower gear ratio when the following conditions are satisfied: a rotational speed setting device is below a third rotational speed value and the rotational speed of the motor is below a third motor rotational speed value.
